(19) United States
(12) Patent Application Publication
(10) Pub. No.: US 2008/0191434 A1
(43) Pub. Date: Aug. 14, 2008

(54) Disposable protective hand engageable shopping cart handle covers

(76) Inventor: Arlene Herron, Culver City, CA (US)

Correspondence Address: Law Offices of Robert J. Schaap, P.O. BOX 950103, Mission Hills, CA, 91395, US

(21) Appl. No.: 11/513,098

(22) Filed: Aug. 29, 2006

(51) Int. Cl. B62B 5/06

(52) U.S. Cl. 280/33.992; 16/431

(57) ABSTRACT

A disposable hand engageable shopping cart handle cover for removable disposition on a shopping cart handle which reduces the contact of a user's hand with the handle of the shopping cart, and thereby reduces or minimizes the possibility of bacterial and other disease causing germs, to the hands of the shopping cart user. The shopping cart handle covers have means for releasable securement, so that they can be readily and easily attached and removed when the user has finished using the shopping cart.

### BACKGROUND OF THE INVENTION

1. Field of the Invention

This invention relates in general to certain new and useful improvements in protective covers to reduce contact of an individual's hand with an area of a shopping cart handle bar which may be entrained with potential disease causing germs. More particularly, the invention relates to mountable and releasable shopping cart handle covers which can be wrapped about the handle of a shopping cart to insulate hand contact of a user of a shopping cart with the handle itself.

2. Brief Description of Related Art

Shopping carts are widely used in a variety of retail and wholesale merchandising facilities. Exemplary thereof is the fact that shopping carts are commonly found in grocery stores and are frequently found in larger sized hardware stores and other facilities where shoppers may purchase a large number of items. Their use is so common and necessary, that many retail operations, in particular, would not be able to maintain a customer base without the use of the shopping carts.

In recent years, there has been a widespread recognition that shopping cart handles are a cause of bacteria concentration and other types of germs and frequently result in illness. Recently, carts were tested at large retail stores such as, Wal-Mart, Target and Toys-A-Us for bacteria, such as Staph bacteria. It was determined that the total bacteria counts with which a user comes into contact on a shopping cart handle was as much as 1000 times that which a human being would encounter in a day. It is known, for example, that the staph bacteria alone can lead to diarrhea, pneumonia and meningitis. Also found on shopping cart handles were salmonella which is a leading cause of food poisoning. Further found were e-coli bacteria.

The Woman's World magazine edition of May 2, 2006 recently reported that handles on shopping carts were teaming with more bacteria than doorknobs on public restrooms. Other relatively recent articles and news reports also provide evidence of large quantities of bacteria are found on shopping cart handles. In fact, the amount of bacteria colonies on shopping cart handles was in some cases at least three times and more than that found on other commonly used hand engageable items.

Notwithstanding the effectiveness of the shopping cart, for both the customer and the facility selling products, is the fact that these shopping cart handles are rarely, if ever, cleaned and have a high concentration of bacteria and other disease causing germs. In fact, it has recently been reported that shopping cart handles have a greater concentration of bacteria and disease causing germs than the door handles of many common public latrines.

Many people abhor the need of lifting a toilet seat for fear of contact with potential disease causing bacteria or other germs. Nevertheless, many of those same people will freely engage the handle of a shopping cart. When the public begins to realize that shopping cart handles are a main source of disease causing germs, many people will be less inclined to engage the handles of a shopping cart without something to insulate their hands, with respect to that handle.

Most facilities which offer the use of shopping carts do not provide any means, whatsoever, for the user to insulate his or her hands from the handle of the shopping cart. It would therefore be highly desirable for the user to have some means to insulate his or her hands from that handle-bar. However, it is impractical for the user to carry gloves to provide that insulation. In many cases, even if the user has resorted to carrying gloves, there will undoubtedly be many situations in which the user forgot to bring the gloves, and would thereby be forced to engage the handle of the shopping cart, or not use same.

### OBJECTS OF THE INVENTION

It is, therefore, a primary object of the present invention to provide a supply of handle-bar covers which can be easily and conveniently carried by a user and which can be applied to a shopping cart, and removable therefrom.

It is another object of the present invention to provide a supply of handle-bar covers of the type stated, in which the covers are disposable, so that there is no need to attempt to retain or recover the handle-bar covers.

It is a further object of the present invention to provide handle-bar covers of the type stated, which can be supplied in a roll, in which each handle-bar cover is separable from another, or in which a large number of handle-bar covers can be stored in a small, compact container, and be dispensed upon need and demand therefor.

It is an additional object of the present invention, to provide a method for enabling a shopper to insulate his or her hands from the handle-bar of a shopping cart.

It is still another salient object of the present invention to provide handle-bar covers which may have the ability to destroy some of the disease causing germs which might otherwise exist on a handle-bar of a shopping cart.

It is another salient object to the present invention to provide a method of insulating a user's hands from the handle-bars of a shopping cart and which is relatively easy to use and is also inexpensive.

With the above and other objects in view, my invention resides in the novel features of form, construction, arrangement and combination of parts and components presently described and pointed out in the claims.

### SUMMARY OF THE INVENTION

The present invention provides a supply of handle-bar covers which are conveniently and easily packed and stored for dispensing or otherwise in an easily transportable apparatus. For example, the apparatus may be that of a small, simple container or roll for dispensing handle-bar covers which allows for disposal after use.

The handle-bar covers usually are provided in the form of a sheet, such as a fabric sheet or, for that matter, paper or a paperboard sheet, which can be wrapped about the handle of a shopping cart. Moreover, each of the covers were provided with means for securing the handle-bar covers to the shopping cart handle. In the embodiment of the invention, these means may adopt the forms of adhesive strips which are located on the handle-bar covers and which can become releasably adhesively attachable to the handle-bars upon engagement therewith.

One of the means of supplying handle-bar covers is that of locating the covers in a box, such that one can be pulled outwardly for disposition. Each cover is engageable with the cover therebeneath, so that it effectively pulls the cover therebeneath to the mouth of the container. In this way, the next cover can also be removed from the supply box.

Another form of cover supply may adopt the form of a roll of handle-bar covers in which one cover is releasably connected to an edge of the next adjacent cover. In this way, one cover can be pulled from the roll and also cause an edge of the next adjacent cover to be pulled to the mouth of the container, so that it may also be engaged by the fingers of a user. This type of supply is highly effective, in that the supply of handle-bar covers can be carried as a small, compact unit and, therefore, immediately available upon need.

A small compact supply is particularly desirable where the handle-bar covers may be carried with a user, such as in the purse of a woman or, for that matter, the purse of a man. They can also be formed of a low-cost material so that they can be manufactured and sold at a relatively low unit cost. Moreover, they would be sufficiently durable to remain on the shopping cart for a reasonable shopping period. In this way, the user would have a supply of shopping cart handle covers when needed.

Handle-bar covers of this type could be carried by the user, as aforesaid. In many cases, and when they become more popular, it is anticipated that retail or wholesale facilities which are offering products for sale, may find it necessary to engage in the offering of such covers as a convenience to the users who shop in that facility.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a fragmentary perspective view of a shopping cart in which a disposable shopping cart handle-bar cover is located on the handle-bar thereof;

FIG. 2 is a perspective view of a protective cover which may be provided for wrapping about the handle-bar of a shopping cart;

FIG. 3 is a perspective view of a supply of shopping cart handle-bar covers in the form of a box with successively dispensable shopping cart handle-bar covers;

FIG. 4 is a perspective view of a roll of shopping cart handle-bar covers in which one cover may be severed from the next adjacent cover as dispensed from the roll; and

FIG. 5 is a sectional view taken through the handle-bar of a shopping cart and showing the cover thereof.

### DETAILED DESCRIPTION OF A PREFERRED EMBODIMENT

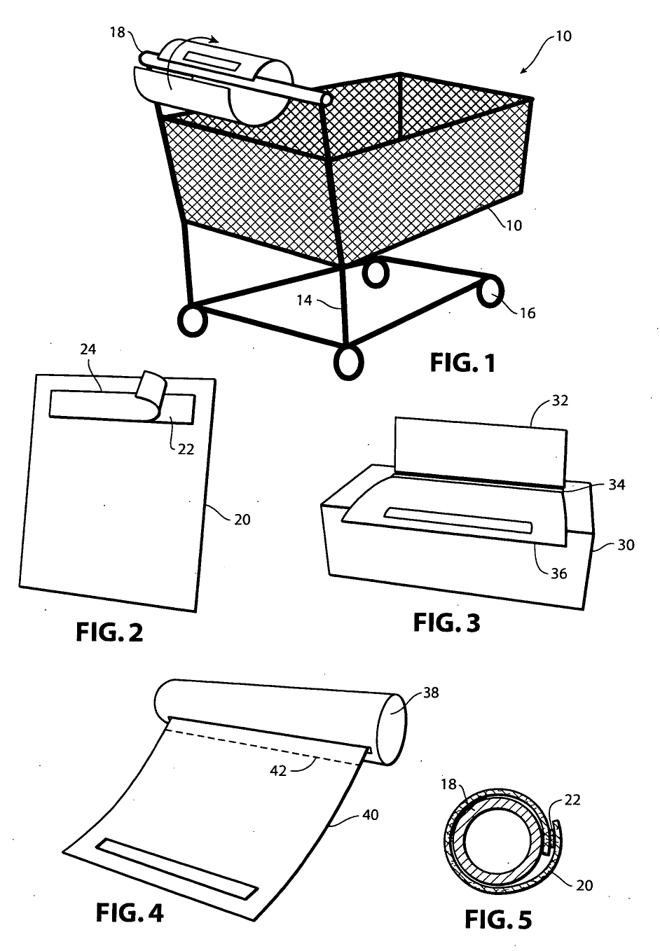

Referring now in more detail in by reference characters to the drawings, which illustrate several practical embodiments of the present invention, FIG. 1 illustrates a conventional shopping cart 10 having a basket 12 mounted on a frame 14 and with conventional wheels 16 for rolling disposition. The cart similarly includes a handle-bar 18 extending transversely across the cart.

As indicated previously, the handle-bar 18 is the source of large quantities of bacteria and other germs. This is not surprising in view of the fact that large numbers of people may use the shopping cart on a single day and rarely do they wash their hands before or after using the shopping cart.

The present invention thereby provides a disposable cover 20 which may be formed of a single sheet of paper or other flexible, foldable and easily storable material. Thus, simple relatively non-porous sheets 20 may be effective for this purpose. Located on one surface of the sheet is an adhesive strip 22 and which may be covered by a removable release strip 24. In this way, the removable release strip may be removed from the adhesive strip 22 in the manner as shown in FIG. 2. Furthermore, the cover may be then disposed about the shopping cart handle 18 and rolled over onto itself so that the adhesive strip 22 engages an oppositely disposed surface, namely the outer surface of the cover 20.

One of the important aspects of the present invention is that the sheet material which is used to produce the covers is relatively inexpensive. In this way, the covers may be disposable after use. For this purpose, waste containers may be provided in proximity to where the shopping carts are stored. It would be easy to quickly remove each of the individual shopping cart covers by an attendant or for that matter the next subsequent user and apply to a selected shopping cart a cover on the handle therefor.

FIG. 3 illustrates one form of supply for shopping cart covers which may be carried with the user. Thus, a box 30 having an openable top 32 opens an access opening 34 so that the covers 36 may be pulled therefrom. In this way, covers may be dispensed much in the same manner as flexible and foldable items are dispensed from a box of such materials.

In another embodiment of the invention, there may be provided a roll 38 of dispensable shopping cart handle covers 40 and which are severable from one another by means of score lines 42. Thus, each cover can be severed from the edge of the next adjacent cover and used on a shopping cart, much in the same manner that paper towels are dispensed from the next adjacent paper towel which is to be dispensed.

When the covers are removed, they can be wrapped about a shopping cart handle 18 much in the manner as shown in FIG. 5 so that each cover completely surrounds and envelopes the shopping cart handle.

Thus, there has been illustrated and described a unique and novel shopping cart handle cover and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what we desire to claim and secure by Letters Patent is:

1. A disposable protective cover for disposition on a handle of a shopping cart to protect the user of the shopping cart from contact with germs on the handle thereof, said handle-bar cover comprising:
a) a single sheet of flexible and rollable material having a pair of end margins and a pair of side margins;
b) said sheet having a width such that the side margins are sufficient to enable the sheet to be rolled about the handle-bar without any excess material therefor;
c) said sheet further having a length such that one end can be rolled about the handle-bar and engageable with an exposed surface of the sheet so as to be attachable thereto; and
d) means for releasably securing one end margin of said sheet to the exposed surface of said sheet for releasable disposition on the handle-bar of a shopping cart.

2. The disposable shopping cart handle cover of claim 1 further characterized in that said sheet is a sheet of paper.

3. The disposable handle-bar cover of claim 2 further characterized in that said sheet of material is a sheet of paper of sufficiently small perosity such that germs and bacteria do not migrate through the sheet.

4. The handle-bar cover of claim 1 further characterized in that the means for releasably attaching the sheet about itself to the handle-bar of a shopping cart is an adhesive means.

5. The disposable shopping cart handle cover of claim 4 further characterized in that said adhesive means comprises a strip of adhesive on one side of the cover with a release strip disposed thereover and which is removable by a user upon application of the handle-bar cover to the handle-bar of a shopping cart.

6. A method of protecting a user's hands from the handle-bar of a shopping cart, said method comprising
a) providing a sheet of flexible and rollable material;
b) rolling said sheet about a handle-bar of a shopping cart; and
c) securing one end of the sheet to the exposed surface of the sheet to releasably secure the shopping cart handle cover to the handle of the shopping cart.

7. The method of claim 6 further characterized in that said sheet is a sheet of paper.

8. The method of claim 6 further characterized in that said method comprises removing a handle-bar cover from a box containing such handle-bar covers and in such manner that when one cover is pulled therefrom, a portion of the next cover is brought to an opening on the box therefor.

9. The method of claim 6 further characterized in that said method comprises tearing a sheet of the handle-bar covers from a roll of same.

10. A flexible and foldable fabric like hand insulator for insulating the handle of a shopping cart used from the handle-bars of that shopping cart, said insulator comprising:
a) a flexible and foldable sheet material cover folded into a small compact unit which can be opened and disposed around the handle-bar of a shopping cart;
b) reliable securement strip elevated at least at one edge of said sheet material and being relatively securable at another portion of said sheet material when disposed around said handle-bar; and
c) whereby said sheet material can be removed from a plurality of like sheet material covers and placed around a shopping cart handle.
